(19) United States
(12) Patent Application Publication
(10) Pub. No.: US 2026/0132644 A1
(43) Pub. Date: May 14, 2026

(54) PORTABLE WORKSTATION TRANSPORTABLE BY FORKLIFT

(71) Applicant: Jacob Alvarado, Cibolo, TX (US)

(72) Inventor: Jacob Alvarado, Cibolo, TX (US)

(21) Appl. No.: 18/946,019

(22) Filed: Nov. 13, 2024

(51) Int. Cl. E04H 1/12; B66F 9/12

(52) U.S. Cl. CPC E04H 1/125; B66F 9/127

(57) ABSTRACT

A portable workstation transportable by forklift includes a pallet, an enclosure, and a work stand. The pallet is designed to be engaged and lifted by forks of a forklift. An enclosure is mounted on the pallet and designed to enclose a person standing on the pallet. A hook assembly is attached to the enclosure. The hook assembly is designed to detachably connect to a back rest of the forklift to further secure the portable workstation to the forklift. The work stand is positioned in the enclosure and includes a top surface designed to support work materials and equipment.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (f) Statement Regarding Prior Disclosures by the Inventor or

### JOINT INVENTOR

Not Applicable

### (g) BACKGROUND OF THE INVENTION

### (1) Field of the Invention

The disclosure relates to portable workstations and more particularly pertains to a new portable workstation for that is designed to be transported on a forklift or unicarrier. When training or supervising work in warehouses and similar environments, it can be challenging for supervising personnel to follow around workers utilizing forklifts as the supervising personnel not only need transportation, but also need computers and other work supplies. The new portable workstation includes a pallet base and built-in workstand to allow the supervising personnel to travel all around a worksite with the employee operator and bring along the workstand.

### (2) Description of Related Art Including Information Disclosed Under 37 CFR 1.97 and 1.98

The prior art relates to portable workstations. The prior art, as best understood, does not disclose a portable workstation transportable by forklift that includes a pallet, an enclosure, and a work stand. The enclosure is mounted on the pallet and designed to enclose a person standing on the pallet. The work stand is positioned in the enclosure and includes a top surface designed to support work materials and equipment.

### (h) BRIEF SUMMARY OF THE INVENTION

An embodiment of the disclosure meets the needs presented above in a portable workstation generally comprising a pallet, an enclosure, and a work stand. The pallet is designed to be engaged and lifted by forks of a forklift. An enclosure is mounted on the pallet and designed to enclose a person standing on the pallet. A hook assembly is attached to the enclosure. The hook assembly is designed to detachably connect to a back rest of the forklift to further secure the portable workstation to the forklift. The work stand is positioned in the enclosure and includes a top surface designed to support work materials and equipment.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a side view of a portable workstation according to an embodiment of the disclosure.

FIG. 2 is a back view of an embodiment of the disclosure.

FIG. 3 is a front view of an embodiment of the disclosure.

FIG. 4 is a top view of an embodiment of the disclosure.

FIG. 5 is a side view of an embodiment of the disclosure in use.

### (j) DETAILED DESCRIPTION OF THE INVENTION

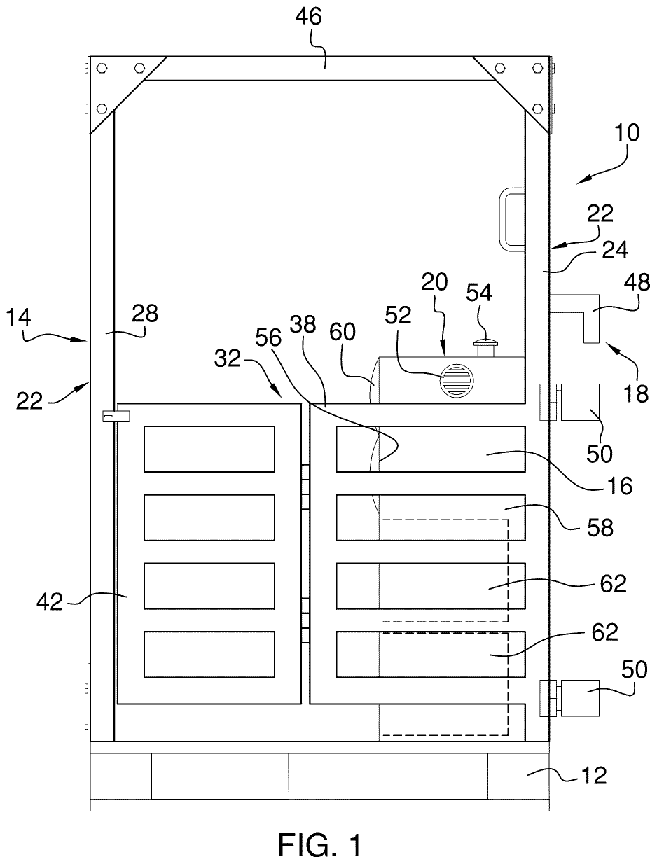

With reference now to the drawings, and in particular to FIGS. 1 through 5 thereof, a new portable workstation embodying the principles and concepts of an embodiment of the disclosure and generally designated by the reference numeral 10 will be described.

As best illustrated in FIGS. 1 through 5, the portable workstation 10 transportable by a forklift 70 generally comprises a pallet 12, an enclosure 14, and a work stand 16. The pallet 12 is designed to be engaged and lifted by forks 72 of a forklift 70. An enclosure 14 is mounted on the pallet 12 and designed to enclose a person standing on the pallet 12. A hook assembly 18 is attached to the enclosure 14. The hook assembly 18 is designed to detachably connect to a back rest 74 of the forklift 70 to further secure the portable workstation 10 to the forklift 70. The work stand 16 is positioned in the enclosure 14 and includes a top surface 20 designed to support work materials and equipment.

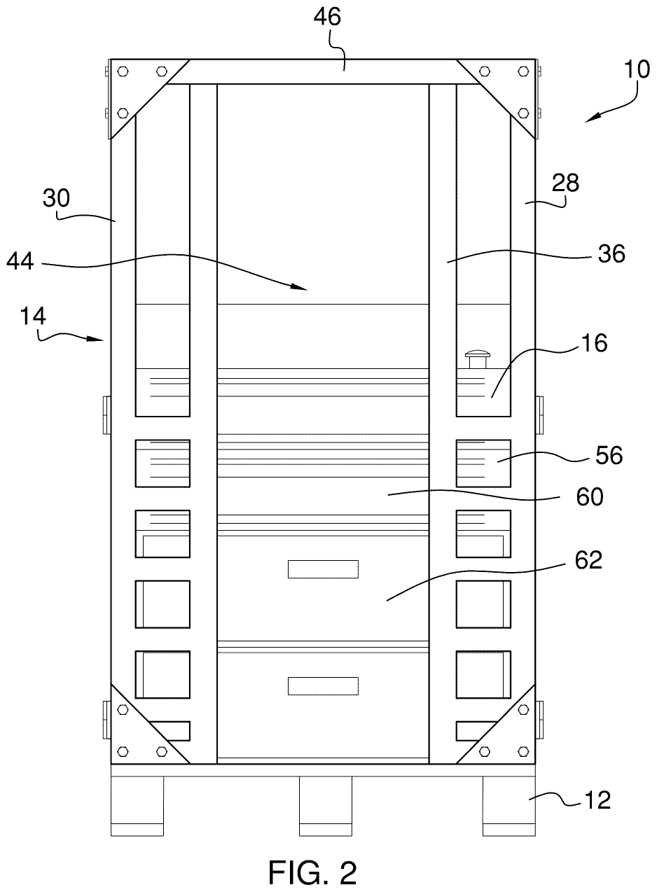

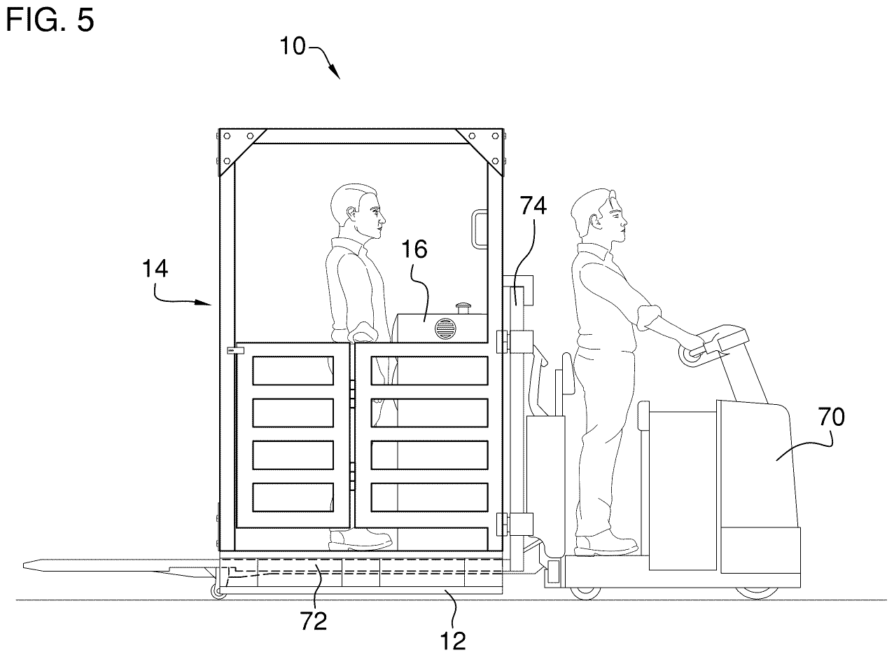

As can be seen in FIGS. 1 and 2, the pallet 12 has a standard configuration, though alternative pallet designs known in the warehouse industry are within the scope of the disclosure. The enclosure 14 includes a plurality of posts, generally referred to as a group by the reference number 22, attached to and projecting vertically from the pallet 12. In the exemplary embodiment in the figures, the posts 22 include a first post 24 and a second post 26 positioned at opposing corner regions of a front end of the pallet 12, as well as a third post 28 and a fourth post 30 positioned at opposing corner regions of a rear end of the pallet 12. A brace 46 couples upper portions of the posts 22. A plurality of barriers, generally referred to as a group by the reference number 32, is attached to the posts 22. The barriers 32 include a front barrier 34 positioned between the first post 24 and the second post 26, a rear barrier 36 positioned between the third post 28 and the fourth post 30, a first side barrier 38 positioned between the first post 24 and the third post 28, and a second side barrier 40 positioned between the second post 26 and the fourth post 30. The posts 22 and barriers 32 are generally designed to permit visibility through the enclosure 14 so that the supervisor in the enclosure 14 can monitor other employees and the worksite in general, as shown in FIG. 5. For example, the barriers 32 could obstruct a lower half of the enclosure 14, such that the supervisor can look out through an open space between posts 22. In another possible embodiment, the barriers 32 could extend further but include windows or transparent material for visibility.

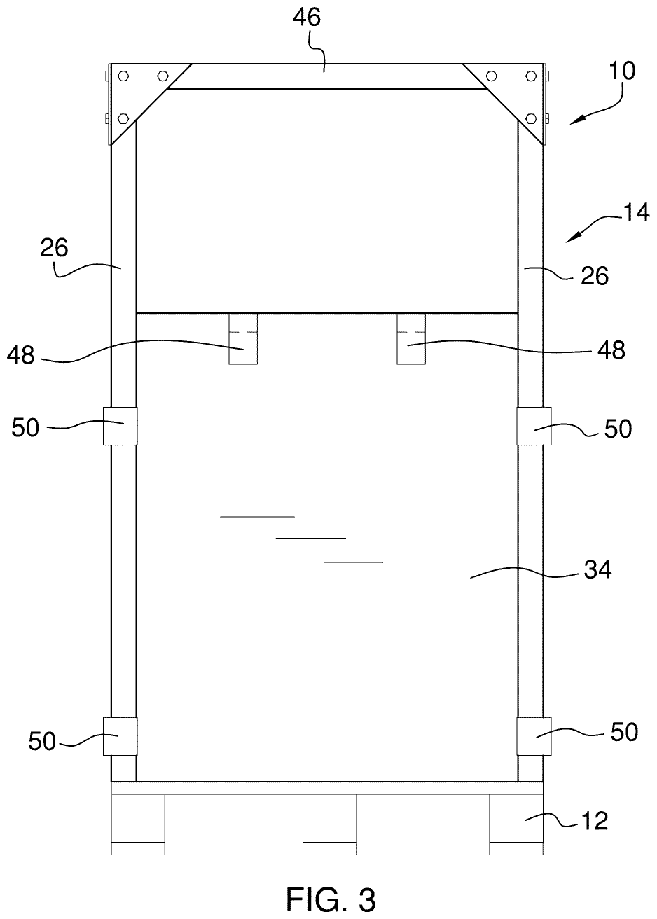

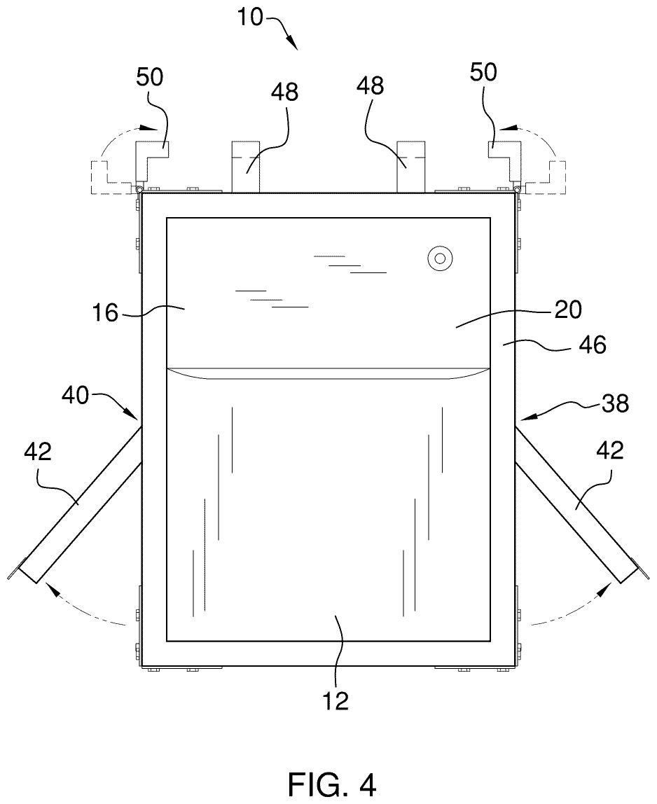

The barriers 32 can be of different designs as the barriers 32 are primarily intended to protect a person inside the enclosure 14, both from impacts and from accidentally falling off of the pallet 12. In the exemplary embodiment best seen in FIGS. 1 and 4, at least one of the side barriers 32, or both as shown in FIG. 4, includes a gate 42 designed to be pivoted open and closed. FIG. 2 shows the rear barrier 36 having a different design, wherein a space 44 extends through the center of the rear barrier 36, effectively dividing the rear barrier 36 into two sections. In one possible embodiment, a movable bar or strap could be placed across this space 44 for safety. FIG. 3 shows the front barrier 34 having yet another design, wherein the front barrier 34 is a solid wall or panel. Any of the barriers 32 could have any of these different designs, as well as other configurations as are well known in the structural arts. The brace 46 at the upper part of the enclosure 14 could be an open frame as shown in FIG. 4, but also could be a solid panel or network of crosspieces or bars.

As shown in FIG. 5, the front barrier 34 is positioned to face toward the back rest 74 of the forklift 70 when the pallet 12 is engaged by the forklift 70. The work stand 16 is attached to the front barrier 34, though the work stand 16 could be attached elsewhere on the enclosure 14 or attached to the pallet 12 or both.

As best shown in FIGS. 1, 4, and 5, the hook assembly 18 includes two suspension brackets 48 attached to an upper portion of the front barrier 34 and designed to hook onto a top portion of the back rest 74 of the forklift 70.

In the exemplary embodiment, the hook assembly 18 also includes a pair of clamping brackets 50. Each of the clamping brackets 50 is pivotably attached to a respective one of the pair of the posts 22 on either side of the front barrier 34. Each of the clamping brackets 50 is designed to be pivoted onto a side portion of the back rest 74 of the forklift 70. The hook assembly 18 as shown is one possible embodiment, and in other possible embodiments different securing devices could be used, such as straps, magnets, and grips.

The work stand 16 itself could have a variety of different designs as desired. In the exemplary embodiment, the work stand 16 includes a horn 52 and an actuator 54 designed to actuate the horn 52. The work stand 16 also includes a front panel 56 and side panels 58 extending downwardly from the top surface 20. The work stand 16 includes protective padding 60 positioned on the front panel 56. The protective padding 60 can protect and support a person standing in the enclosure 14, especially during transport as shown in FIG. 5. The work stand 16 also includes drawers 62 positioned between the side panels 58 and movable back and forth through respective apertures in the front panel 56. Again, these various components are only one exemplary embodiment, and the work stand 16 could include a variety of other components, such as a battery with outlets for different electronic devices, lights, shelves, containers, and other components suitable for a work stand 16.

FIG. 5 shows the portable workstation 10 in use. The forks 72 of the forklift 70, also known as a pallet carrier or unicarrier, have been inserted into the pallet 12 and then lifted off of the ground. When lifted, the back rest 74 of the forklift 70 engages the suspension brackets 48. The clamping brackets 50 are then clamped onto the sides of the back rest 74. In this manner, the portable workstation 10 is very securely connected to the forklift 70. The supervisor can now ride with the employee operating the forklift 70 to supervise the operation of the forklift 70. The portable workstation 10 can be disconnected from the forklift 70 to permit the supervisor to work and supervise in a work area.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A portable workstation transportable by forklift comprising:
a pallet configured to be engaged and lifted by forks of a forklift;
an enclosure being mounted on said pallet and configured to enclose a person standing on said pallet;
a hook assembly being attached to said enclosure, said hook assembly being configured to detachably connect to a back rest of the forklift to further secure the portable workstation to the forklift; and
a work stand being disposed in said enclosure, said work stand including a top surface being configured to support work materials and equipment.

2. The portable workstation of claim 1, wherein said enclosure includes:
a plurality of posts being attached to and projecting vertically from said pallet, said posts including a first post and a second post disposed at opposing corner regions of a front end of said pallet, said posts including a third post and a fourth post disposed at opposing corner regions of a rear end of said pallet;
a brace coupling upper portions of said posts;
a plurality of barriers attached to said posts, said barriers including:
a front barrier disposed between said first post and said second post;
a rear barrier disposed between said third post and said fourth post;
a first side barrier disposed between said first post and said third post; and
a second side barrier disposed between said second post and said fourth post.

3. The portable workstation of claim 2, wherein said front barrier is disposed to face toward the back rest of the forklift when said pallet is engaged by the forklift.

4. The portable workstation of claim 3, wherein said work stand is attached to said front barrier.

5. The portable workstation of claim 3, wherein said hook assembly includes two suspension brackets attached to an upper portion of said front barrier and configured to hook onto a top portion of the back rest of the forklift.

6. The portable workstation of claim 3, wherein:
said hook assembly includes a pair of clamping brackets;
each of said clamping brackets is pivotably attached to a respective one of said pair of said posts on either side of said front barrier; and
each of said clamping brackets is configured to be pivoted onto a side portion of the back rest of the forklift.

7. The portable workstation of claim 2, wherein at least one of said side barriers includes a gate configured to be pivoted open and closed.

8. The portable workstation of claim 1, wherein said work stand includes a horn and an actuator configured to actuate said horn.

9. The portable workstation of claim 1, wherein:
said work stand includes a front panel and side panels extending downwardly from said top surface; and
said work stand includes protective padding disposed on said front panel.

10. The portable workstation of claim 1, wherein:
said work stand includes a front panel and side panels extending downwardly from said top surface; and
said work stand includes drawers disposed between said side panels and movable back and forth through respective apertures in said front panel.

11. The portable workstation of claim 4, wherein said hook assembly includes two suspension brackets attached to an upper portion of said front barrier and configured to hook onto a top portion of the back rest of the forklift.

12. The portable workstation of claim 11, wherein:
said hook assembly includes a pair of clamping brackets;
each of said clamping brackets is pivotably attached to a respective one of said pair of said posts on either side of said front barrier; and
each of said clamping brackets is configured to be pivoted onto a side portion of the back rest of the forklift.

13. The portable workstation of claim 12, wherein at least one of said side barriers includes a gate configured to be pivoted open and closed.

14. The portable workstation of claim 13, wherein said work stand includes a horn and an actuator configured to actuate said horn.

15. The portable workstation of claim 14, wherein:
said work stand includes a front panel and side panels extending downwardly from said top surface; and
said work stand includes protective padding disposed on said front panel.

16. The portable workstation of claim 15, wherein:
said work stand includes a front panel and side panels extending downwardly from said top surface; and
said work stand includes drawers disposed between said side panels and movable back and forth through respective apertures in said front panel.
